(19) United States
(12) Patent Application Publication
(10) Pub. No.: US 2024/0018719 A1
(43) Pub. Date: Jan. 18, 2024

(54) METHOD OF DRYING PAPER USING INDUCTIVE ENERGY AND RELATED PAPERMAKING MACHINE DRYER SECTION AND INDUSTRIAL TEXTILES

(71) Applicant: AstenJohnson International, Inc., Charleston, SC (US)

(72) Inventors: Ted BORGERDING, Dayton, OH (US); John STOLARZ, Circleville, OH (US); Daniel HEDOU, Clinton, SC (US); Samantha RYAN, Barre, VT (US)

(73) Assignee: AstenJohnson International, Inc., Charleston, SC (US)

(21) Appl. No.: 18/034,726

(22) PCT Filed: Oct. 29, 2021
(86) PCT No.: PCT/US2021/057381

§ 371 Date: May 1, 2023

Related U.S. Application Data
(60) Provisional application No. 63/193,671, filed on May 27, 2021.
(60) Provisional application No. 63/152,055, filed on Feb. 22, 2021.
(60) Provisional application No. 63/122,166, filed on Dec. 7, 2020.
(60) Provisional application No. 63/107,807, filed on Oct. 30, 2020.

(51) Int. Cl. D21F 5/16; F26B 13/10; F26B 13/18; D21F 7/12; D21F 7/08

(52) U.S. Cl. CPC D21F 5/165; F26B 13/10; F26B 13/18; D21F 7/12; D21F 7/083

(57) ABSTRACT

A papermaking machine having at least one of a dryer section or a press section configured to receive a web of material, at least one inductive energy generator, and first and second fabrics, which can be dryer or press fabrics, including induction heat susceptors. The first and second fabrics are supported for movement through the at least one of the dryer section or the press section and adapted to contact the web of material. The inductive energy generator is used to generate heat in the induction heat susceptors in order to heat a paper web being carried by the fabrics in order to remove moisture.

### CROSS REFERENCE TO RELATED APPLICATIONS

This application claims the benefit of U.S. Provisional Application No. 63/107,807, filed Oct. 30, 2020, U.S. Provisional Application No. 63/122,166, filed Dec. 7, 2020, U.S. Provisional Application No. 63/152,055, filed Feb. 22, 2021 and U.S. Provisional Application No. 63/193,671, May 27, 2021, the contents of which are incorporated herein by reference.

### TECHNICAL FIELD

The invention relates to papermaking machines, and more particularly to dryer sections.

### BACKGROUND

The dryer section of the paper machine typically uses steam heated dryer cans to dry the paper web being conveyed through it. Steam heating is typical and requires a lot of thermal inertia (time to heat up and cool down). Drying costs are one of the most significant costs in paper manufacturing and drying consumes a large amount of energy which has a large environmental impact. It would be desirable to have a more economical, efficient, and environmentally friendly alternative to drying paper.

### SUMMARY

In one aspect, the invention concerns a papermaking machine, and more particularly can be used in the papermaking machine dryer section or press section. For this application, at least one of the dryer section or the press section in a papermaking machine would be configured to receive a web of material and would include at least one inductive energy generator and at least one fabric in the form or of a dryer fabric or a press fabric or felt comprising induction heat susceptors, with the at least one fabric supported for movement throughout the dryer section. The fabric could be a dryer fabric or a press fabric.

In connection with the use of the invention in a dryer section of a papermaking machine, here, at least a first dryer fabric is provided that comprises induction heat susceptors. In one preferred application, a first dryer fabric and a second dryer fabric are provided, with the first dryer fabric located proximate to the second dryer fabric along at least a part of a web path to define a web support space therebetween in which the web of material is adapted to be carried. At least one of the first dryer fabric and the second dryer fabric would comprise the induction heat susceptors.

In one embodiment the dryer fabric comprising the induction heat susceptors is a woven fabric comprising a plurality of filaments and at least a portion of the filaments comprise induction heat susceptive material. In another embodiment the dryer fabric is a permeable nonwoven fabric that includes an induction heat susceptive material. In an additional embodiment the dryer fabric has an induction heat susceptive coating.

In a preferred embodiment the inductive energy generator is an induction heat generating cell. In embodiments where there are two dryer fabrics running along the web path, both fabrics may be heated by the same induction heat generating cell as the induction energy would pass through the paper web located between the two fabrics. In an alternative embodiment, the inductive energy generator may be a thermal insulated rotary roller, where the thermal insulated roller may be a ceramic roller or a thermal set polymer construction. The dryer section may include a plurality of induction energy generators. The plurality of inductive energy generators may be offset. The plurality of inductive energy generators may be staggered. Where the inductive energy generators are staggered across the cross machine direction of the dryer section, the inductive energy generators would allow for cross machine direction moisture profile correction across the paper web as the amount of induction heat transfer from each induction heat generator could be adjusted. Additionally, the induction heat generating cell can be located, for example, between adjacent areas or runs of the fabrics or in an area of a return run after the paper being carried is delivered to a further section of the papermaking equipment.

The dryer section may include a moisture removal source. The moisture removal source may be a vacuum source, a roller source, a desiccator, a mass transfer recovery source, or an over-pressure device. In an embodiment where the moisture removal source is a vacuum source, the vacuum source may be a rotary vacuum or a stationary element vacuum. In a preferred embodiment, the vacuum source is a low-vacuum unit—a box connected to a blower which creates a negative air pressure to capture moist air evaporating from the web, using a low suction high volume blower to generate the vacuum. Where the moisture removal source is a roller source, there may be an atmospheric roller and a low-pressure roller utilized for moisture displacement and recovery. Where the moisture removal source is a mass transfer recovery source the water from the paper web is captured and reused in the papermaking process. Where the moisture removal source is an over-pressure device, the over-pressure device may be a pressurized blow-box, a pressurized roller, or a stationary blowbox. The dryer section may include a plurality of moisture removal sources.

The dryer section may include a transfer source. The transfer source may be a vacuum, a suction nip roller, or an air pipe that produces a focused jet of air to redirect the paper web from a preceding fabric. In a preferred embodiment, the transfer source is a vacuum.

The dryer section provides support for movement for the dryer fabric. In one embodiment, the dryer fabric may be supported for movement by a plurality of rollers. In another embodiment, it may be supported by at least one vacuum source. In an additional embodiment, it may be supported by at least one stationary foil. In a further embodiment, it may be supported by at least one rotary shield moisture recovery unit.

In a preferred embodiment, the dryer fabric in the dryer section is supported by a plurality of rollers. The rollers may include at least one of primary rollers, carrier rollers, guide rollers, or felt rollers. The primary rollers may include drive rollers or stretch rollers. In a preferred embodiment there are four primary rollers. In a further preferred embodiment, the four primary rollers include two driver rollers and two stretch rollers.

In a preferred embodiment, the dryer section includes at least one guide roller for each dryer fabric.

In a preferred embodiment, the dryer section includes at least one load cell configured to measure tension on the dryer fabric. Preferably load cells are included near the entrance and exit of the dryer section.

In one embodiment, the dryer section includes at least one rotating perforated vacuum roller. The rotating perforated vacuum roller is proximate to at least one inductive energy generator.

The papermaking machine may include a plurality of dryer sections.

The invention also concerns an industrial textile, preferably a dryer fabric for a papermaking machine. The industrial textile comprises a fabric having first and second opposing surfaces, and an induction heating susceptive material.

In one embodiment, the industrial textile is woven. In an alternative embodiment, the industrial textile is a permeable nonwoven fabric. In one embodiment, the industrial textile includes induction heating susceptive filaments in at least one of the machine direction or cross machine direction. The induction heating susceptive filaments may be metallic or a combination of metallic and polymeric materials, and are preferably electrically conductive, magnetic, high thermal diffusivity material, and may alternate with polymeric filaments within the weave pattern.

In another embodiment, the industrial textile includes induction heating susceptive fibers formed of a polymer blended with an induction heating susceptive material. In an additional embodiment, the industrial textile includes an induction heating susceptive coating. The coating may be on at least one of the first or second opposing surfaces. In an additional embodiment, the induction heating susceptible material may contain at least one of graphite or magnetite.

The mass and/or contact surface area of the induction susceptive material is preferably optimized as having more mass and/or contact surface area is more efficient, with a combination of the two being preferred.

Preferably the induction heating susceptive filaments are arranged in the industrial textile so that they are oriented at 90° to the induction heat generating coil primary direction of current flow.

The invention further concerns a method of drying a paper web in the dryer section of a papermaking machine. The method includes receiving a paper web into a paper machine dryer section, conveying the paper web along a conveying path through the paper machine dryer section in contact with a dryer fabric comprising induction heat susceptors, and heating the paper web by applying energy from at least one induction heat generator that activates the induction heat susceptors to generate heat.

In a preferred embodiment the inductive heat generator heats the dryer fabric comprising induction heat susceptors which then heats the paper web.

A preferred method includes providing a second dryer fabric comprising induction heat susceptors in the paper machine dryer section and conveying the paper web sandwiched between the dryer fabrics along the conveying path through at least a portion of the paper machine dryer section.

In one embodiment, the induction heat generator includes a plurality of induction heat generators that are spaced apart along the conveying path, and the method further comprises heating the paper web by applying energy from the plurality of induction heat generators that activate the induction heat susceptors to generate heat to dry the paper web.

The method may also include removing moisture from the dryer section by applying one of a vacuum, a roller, a desiccator, or a mass transfer recovery source. Removing moisture from the dryer section may be done by applying a vacuum to the paper web at spaced apart intervals as the paper web is moved along the conveying path.

The resulting constructions should provide a more economical, efficient, and environmentally-friendly papermaking machine dryer section. Induction heating is a more efficient drying technique in comparison to the existing steam heating technique, with lower drive power and consumption. The electrical power used for induction heating is also more sustainable than the boilers currently used to generate steam for the conventional papermaking machine dryer sections. Increased production is also attainable with more tons produced per hour at a reduced cost per ton.

An additional benefit includes the reduction of open draws, which are where sheet breaks occur. Stronger webs are also produced due to less stretching and draw. A faster set-up and heat-up is obtained, as time required for machine threading and start-up heating is reduced. Induction heating also provides the potential to reduce the dryer section footprint, it is estimated that the dryer section footprint of conventional papermaking machines may be reduced to roughly half their current size, and even potentially to roughly a quarter of their current size. There would be no need for condensate management or complex hoods.

In another aspect, the induction heat susceptor may be present as various components of the dryer section. In one preferred embodiment the induction heat susceptor is a dryer cylinder. The dryer cylinders may comprise bearings surrounding the outer radius of the cylinder, with top cylinders being suspended from the machine frame and bottom cylinders being supported by the frame. This outer bearing arrangement allows existing dryer cylinders to be retrofitted by removing the front and rear heads, providing dryers that are now truly cylinders and not steam pressurized vessels. Induction cells may be mounted across the full interior face of a cylinder providing for extremely efficient heating of the cylinder. The section can now be easily felt driven due to the significantly reduced weight. Vacuum dryer cylinders may also be retrofitted with high vacuum units mounted inside the cylinder. Both retrofitted dryer cylinders and retrofitted vacuum dryer cylinders may be used in tandem. Applying this arrangement to just one or two cylinders provides total corrective control to even the worst of dryer moisture profile issues.

In an alternative embodiment the induction heat susceptor is a steel susceptor plate. The steel susceptor plate may be an air pressure vented steel susceptor plate. It may be capped on both ends to create an air cushion to allow the sheet to travel over the susceptor plate.

With respect to the press section, the induction heat generating cell can be the same as discussed above. The induction heat generating cells van be located in the area of the web of material or along return runs of the press felt(s).

The press fabric can be constructed in a similar manner as the dryer fabric with the induction heat susceptors in the woven fabric, with at least a portion of the filaments in the base fabric comprising induction heat susceptive material, or a nonwoven fabric that includes an induction heat susceptive material. Additionally, the induction heat susceptive material can be provided in the batt fibers and or a scrim needled to the base fabric.

Studies by Applicant have shown that heat transfer per unit area to the material web being carried should be two or more times as great with an induction energy generator in comparison with standard heat transfer values seen for conventional dryer fabrics.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a schematic cross-sectional view of a dryer section of a papermaking machine according to a first embodiment of the invention.

FIG. 2 is a schematic cross-sectional view of a dryer section of a papermaking machine according to a second embodiment of the invention.

FIG. 3A is a schematic cross-sectional view of a dryer section of a papermaking machine according to a third embodiment of the invention.

FIG. 3B is a detailed view of a segment of the dryer section of FIG. 3A.

FIG. 4 is a schematic cross-sectional view of a dryer section of a papermaking machine according to a fourth embodiment of the invention.

FIG. 4A is a schematic cross-sectional view of a dryer section of a papermaking machine with the induction heat generating cell located along the return fabric run.

FIG. 5 is a schematic cross-sectional view of a segment of a dryer section of a papermaking machine according to a fifth embodiment of the invention.

FIG. 6 is a schematic cross-sectional view of a segment of a dryer section of a papermaking machine according to a sixth embodiment of the invention.

FIG. 7 is a schematic cross-sectional view of a section-to-section transfer of two dryer sections of a papermaking machine according to a first embodiment of the invention.

FIG. 8 is a schematic cross-sectional view of a section-to-section transfer of two dryer sections of a papermaking machine according to a second embodiment of the invention.

FIG. 9A is a schematic cross-sectional view of a woven fabric with cross machine direction filaments comprising induction heat susceptible material.

FIG. 9B is a schematic cross-sectional view of a woven fabric with machine direction filaments comprising induction heat susceptible material.

FIG. 9C is a schematic cross-sectional view of a woven fabric with both machine direction filaments and cross-machine direction filaments comprising induction heat susceptible material.

FIG. 9D is a schematic cross-sectional view of a woven fabric with machine direction filaments comprising induction heat susceptible material and cross-machine direction filaments comprising a combination of filaments comprising induction heat susceptible material and filaments not comprising induction heat susceptible material.

FIG. 9E is a schematic cross-sectional view of a woven fabric with cross machine direction filaments comprising induction heat susceptible material as well as a stuffer filament (shown for illustrative purposes prior to the two opposing ends of the fabric being joined by a pintle) that comprises induction heat susceptible material.

FIG. 9F is a cross-section through a metal filament.

FIG. 9G is a cross-section through a metal filament with a polymeric coating.

FIG. 10 is a plan view of a segment of a permeable nonwoven fabric comprising induction heat susceptible material.

FIG. 11A is a schematic cross-sectional view of a woven fabric with a coating comprising induction heat susceptive material applied to the upper surface.

FIG. 11B is a schematic cross-sectional view of a woven fabric with a coating comprising induction heat susceptive material applied to the lower surface.

FIG. 11C is a schematic cross-sectional view of a woven fabric with a coating comprising induction heat susceptive material applied to the upper and lower surfaces.

FIG. 12A is a schematic cross-sectional view of a metallic filament.

FIG. 12B is a schematic cross-sectional view of a filament that comprises metallic and polymeric materials.

FIG. 13 is a flow-chart outlining the method of drying a web of material.

FIG. 14 is a plan view showing the first step in the formation of an induction coil according to one embodiment for an induction heat generating cell.

FIG. 15 is a view of the conduction coil of FIG. 14 shown after a second step in which the induction coil is bent at a medial position so that two portions of the coil face one another and define a gap therebetween for the web path.

FIG. 16 is a top view of the induction coil shown in FIG. 15.

FIG. 17 is a plan view of an exemplary dryer fabric.

FIG. 18 is a top view showing the exemplary dryer fabric of FIG. 17 passing through the induction coil of FIGS. 15 and 16.

FIG. 19 is a schematic cross-sectional view of a dryer section of a papermaking machine similar to the embodiment of FIG. 1 using induction heat generating cells having the induction coil of FIGS. 15 and 16.

FIG. 20 is a top view of an alternate arrangement of induction coils formed as separate pancake style coils arranged flat to face the fabric and spaced apart in the cross-machine direction of the dryer fabric.

FIG. 21 is a side edge view of the arrangement of FIG. 20.

FIG. 22 is a perspective schematic view of a further alternate arrangement of an induction coil formed as a single coil that extends across the cross-machine direction of the dryer fabric.

FIG. 23 is a schematic perspective view of the arrangement of FIG. 22 looking more directly at the side at the induction coil and one edge of the dryer fabric.

FIG. 24 is a schematic cross-sectional view of a dryer section of a papermaking machine according to a further embodiment that is arranged with the induction coil arrangement of either FIG. 20 or 22 along the path of the dryer fabric(s).

FIG. 25 is a top view of an alternate arrangement of induction coils formed as separate pancake style coils arranged flat face to the fabric and spaced apart in the machine direction of the dryer fabric.

FIG. 26 is a side edge view of the arrangement of FIG. 25.

FIG. 27 is a perspective schematic view of a further alternate arrangement of an induction coil formed as a single coil that extends in the machine direction of the dryer fabric.

FIG. 28 is a schematic perspective view of the arrangement of FIG. 27 looking more directly at from the side at the induction coil and the dryer fabric extending through aligned central opening thereof.

FIG. 29 is a schematic cross-sectional view of a dryer section of a papermaking machine according to a further embodiment that is arranged with the induction coil arrangement of either FIG. 25 or 27 along the path of the dryer fabric(s).

FIG. 30 is a plan view of an alternate embodiment of an induction coil for an induction heat generating cell.

FIG. 31 is a plan view of another embodiment of an induction coil in the form of a pancake coil for an induction heat generating cell.

FIG. 32 is a schematic cross-sectional view of a dryer section of a papermaking machine according to a first embodiment of the invention. solid shell.

FIG. 33A is a schematic cross-sectional side view through a dryer cylinder with a

FIG. 33B is an end view of the dryer cylinder of FIG. 33A.

FIG. 33C is a schematic side elevational view of a dryer cylinder with a drilled or perforated shell.

FIG. 33D is an end view of the dryer cylinder of FIG. 33C.

FIG. 34 is a schematic cross-sectional view of a dryer section of a papermaking machine according to a second embodiment of the invention.

FIG. 35 is a flow-chart outlining the method of drying a web of material.

FIG. 36 is a schematic view of a press section of a papermaking machine according to an embodiment of the invention.

FIG. 37 is a cross-section through an exemplary press felt.

### DETAILED DESCRIPTION

Certain terminology is used in the following description for convenience only and is not limiting. The dryer section 10 according to the invention is that of a papermaking machine. Opposing sides of a fabric may represent first and second, top and bottom, or upper and lower surfaces of the fabric. Filament is used to generically identify a monofilament or multifilament fiber. Warp and weft are used to designate filaments based on their position in the loom that extend in perpendicular directions in the fabric and either could be a machine direction or cross-machine direction filament in the fabric once it is installed on a papermaking machine. Machine direction and cross-machine direction filaments may include interwoven warp and weft filaments as well as inserted filaments that extend in either the machine or cross-machine directions, including stuffer filaments located at the seam or other areas of the fabric.

In describing different embodiments, like element numbers are used for elements having the same function, even if there are minor differences in the specific components identified.

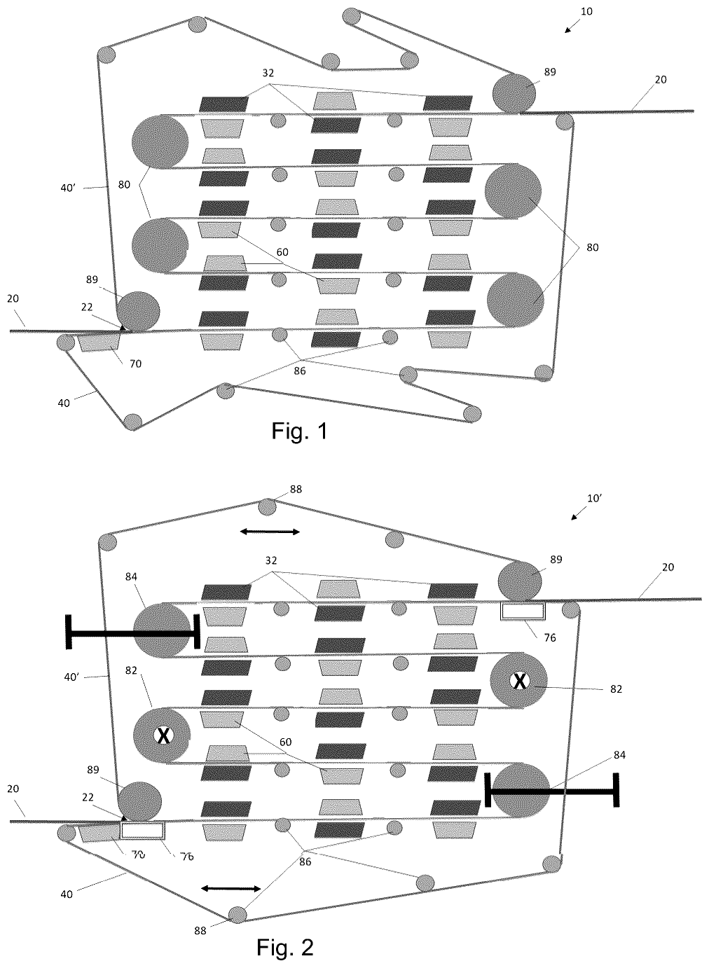

Referring to FIG. 1, a first embodiment of a dryer section 10 according to the invention will be described in further detail. The dryer section 10 is configured to receive a web of material 20, a paper web, along at least part of a web path of a web support space 22 defined by at least one dryer fabric 40 equipped with induction heat susceptors, and more preferably two dryer fabrics 40, 40′. The dryer section 10 has at least one inductive energy generator, shown here as induction heat generating cells 32. An induction heat generating cell 32 may be a coiled, annealed, copper tubing, or Litz wire, that when energized with electricity produces an electromagnetic field. An exemplary pancake coil 33 is shown in FIG. 31 and each induction heat generating cell 32 may have one or more of such coils 33. The coil may be encapsulated in a thermoplastic or other suitable material to provide damage and/or wear protection. The induction heat susceptors of the dryer fabrics 40, 40′ capture the electromagnetic field and produce heat from the eddy currents by the Maxwell-Lodge effect. In the preferred embodiment, the susceptors will be perpendicular in physical orientation to the current flow to maximize the coupling with the electromagnetic field (EMF) generated by the induction heat generating cells 32. As the dryer fabrics 40, 40′ convey the web of material 20 through the dryer section 10, they are supported for movement in this embodiment by primary rollers 80, carrier rollers 86, and felt rollers 89. The dryer section may also include at least one moisture removal device, in this embodiment represented by stationary vacuums 60. The vacuums may be formed as one or more low vacuum units, a box connected to a blower which creates a negative air pressure to capture moist air evaporating from the web, using a low suction high volume blower to generate the vacuum. The dryer section may also include at least one transfer source, in this embodiment represented by a transfer vacuum 70.

Referring to FIG. 2, a second embodiment of a dryer section 10′ according to the invention is shown. The dryer section 10′ is formed in a similar manner to the dryer section 10. This embodiment of the dryer section 10′ includes a plurality of drive rollers 82 and stretch rollers 84. A guide roller 88 configured to be moved to control fabric tension has been included for each of the dryer fabrics 40, 40′. Load cells 76 have also been included and are configured to measure tension on the dryer fabrics 40, 40′.

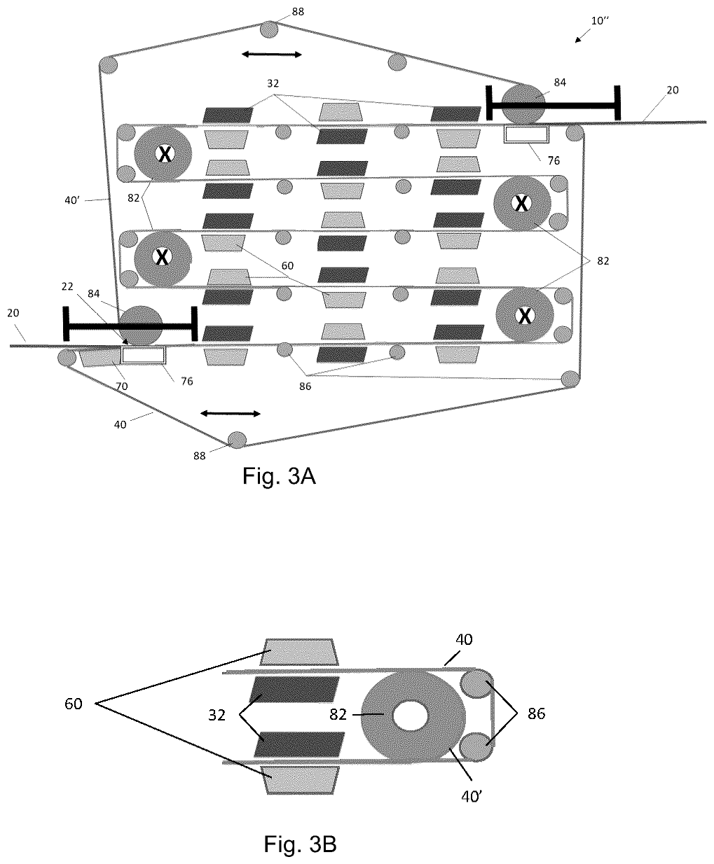

Referring to FIG. 3A, a third embodiment of a dryer section 10″ according to the invention is shown. Similar in structure to both dryer sections 10 and 10′, this embodiment displays an alternative configuration and number of drive rollers 82 and stretch rollers 84. In this embodiment additional carrier rollers 86 have been arranged beyond each drive roller 82 proximate the edges of the dryer section 10″. FIG. 3B displays a close up view of one segment of a drive roller 82 and corresponding carrier rollers 86 to show that the inner dryer fabric 40′ wraps around the drive roller 82 while the outer fabric separates and extends out and wraps around two carrier rollers 86. This configuration is to negate any speed mismatch effect on the material web 20.

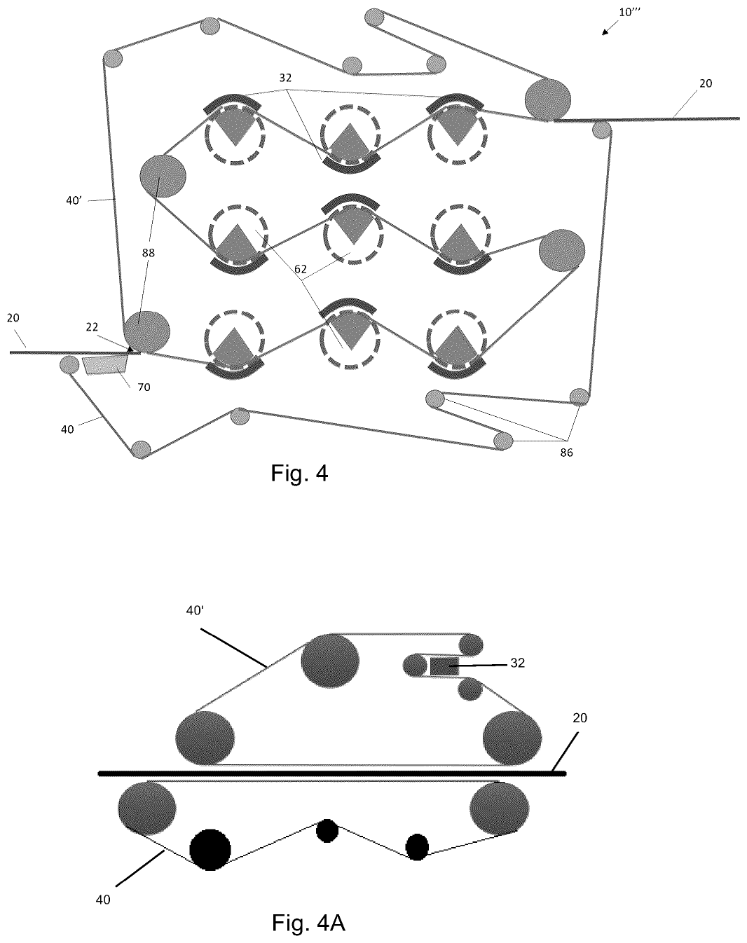

Referring to FIG. 4, a fourth embodiment of a dryer section 10″′ according to the invention is shown. In this embodiment, the stationary vacuums 60 of dryer section 10 are replaced with rotary vacuums 62, which may be contained within perforated rollers.

FIG. 5 shows a segment of a dryer section of a papermaking machine according to a fifth embodiment of the invention. In this embodiment the segment of the dryer section alternates the induction heat generating cells 32 with the vacuums 60 along the web path of the web of material 20, with induction heat generating cells 32 on opposing sides of the dryer fabrics 40, 40′ located opposite other induction heat generating cells 32 while vacuums 60 on opposing side of the dryer fabrics 40, 40′ are located opposite other vacuums 60. Hot air doctors 78 are located proximate each of the vacuums 60.

FIG. 6 shows a segment of a dryer section of a papermaking machine according to a sixth embodiment of the invention. In this embodiment, the segment of the dryer section alternates the induction heat generating cells 32 with the vacuums 60 along the web path of the web of material 20, with induction heat generating cells 32 located opposite vacuums on opposing sides of the dryer fabrics 40, 40′. Hot air doctors 78 are also located proximate each of the vacuums 60.

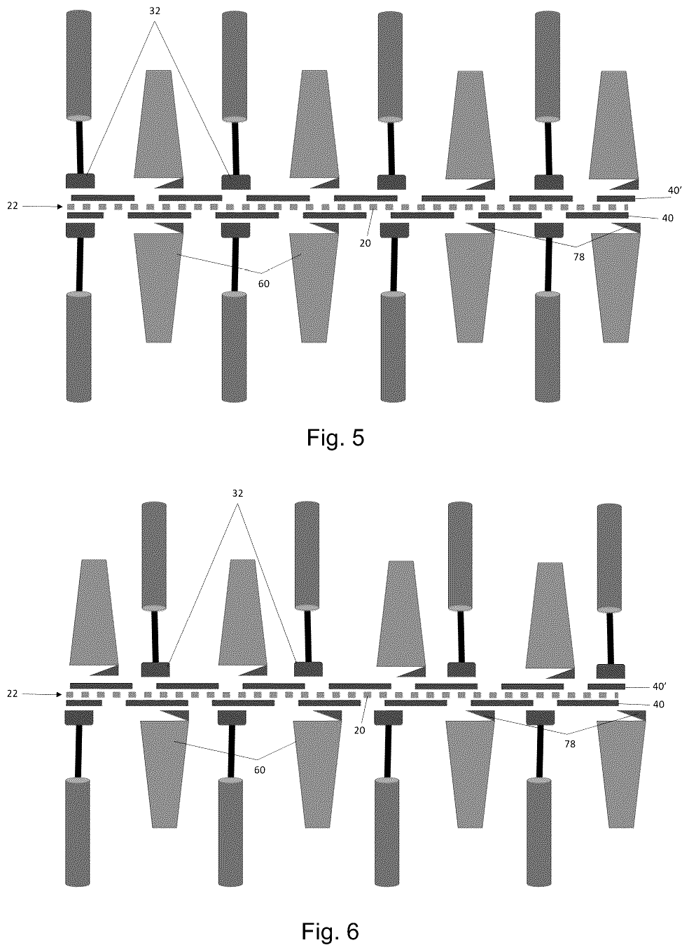

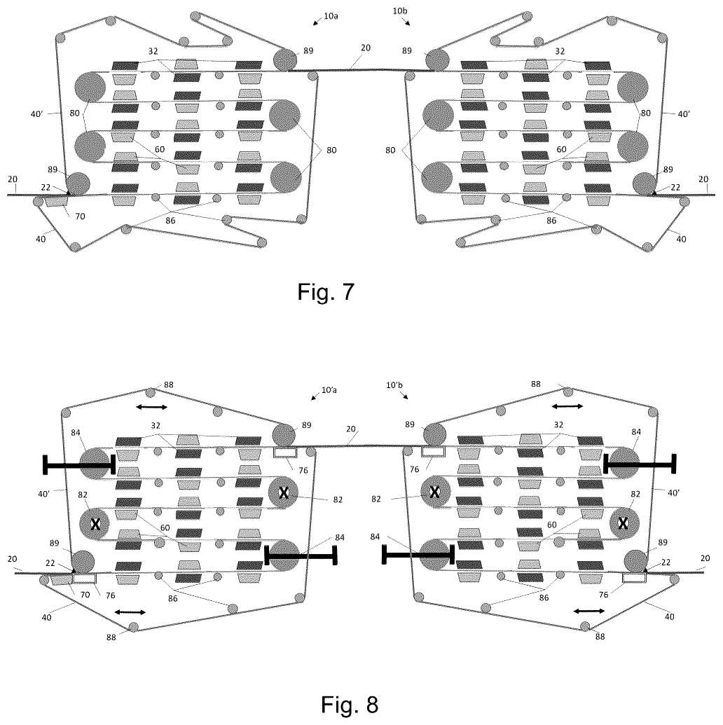

FIG. 7 shows the section to section transfer of a web of material 20 between two dryer sections 10a and 10b according to a first embodiment of the invention. Once the web of material 20 passes the transfer vacuum 70 of the first dryer section 10a it will be totally supported and sandwiched between the dryer fabrics 40, 40′ until it exits the section and passes into the next section which is a similar section where the web path runs from the top to the bottom of the section instead of from the bottom to the top.

FIG. 8 shows the section to section transfer, similar to FIG. 7, of a web of material between two dryer sections 10′a and 10′b according to a second embodiment of the invention.

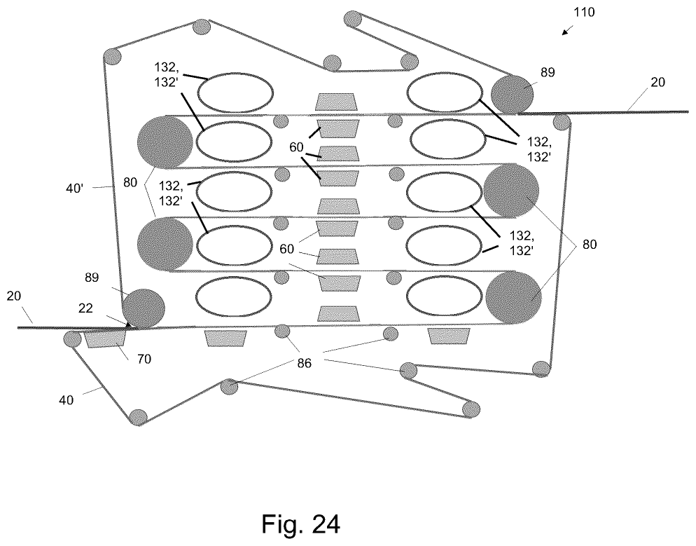

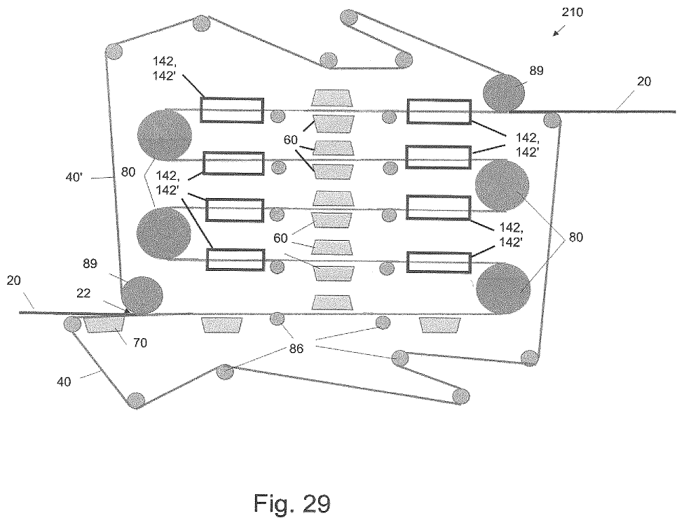

The induction heat generating cells 32 in each of the above embodiments could also be located at additional or alternative positions along the runs of one or both of the dryer fabrics 40, 40′. For example, the induction heat generating cells 32 could be provided on one or both return runs (after the area where the fabrics 40, 40′ separate from being on top of each other where the web of material 20 exits). See for example FIG. 4A where the induction heat generating cell 32 is located on the return run of the dryer fabric 40′. Here, the induction heat generating cell is located between and proximate two sections of the dryer fabrics 40′. This location of the induction heat generating cell between two sections of the dryer fabrics is also shown in connection with FIGS. 24 and 29 below.

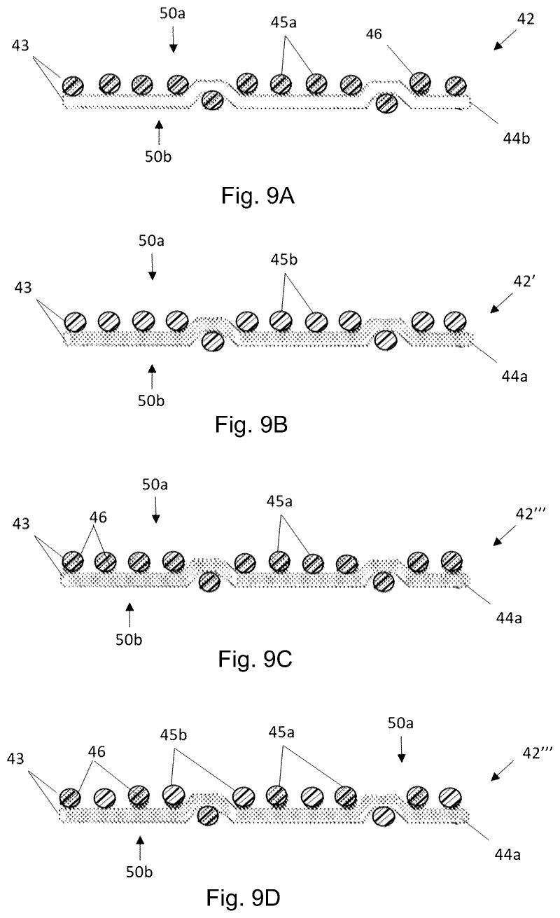

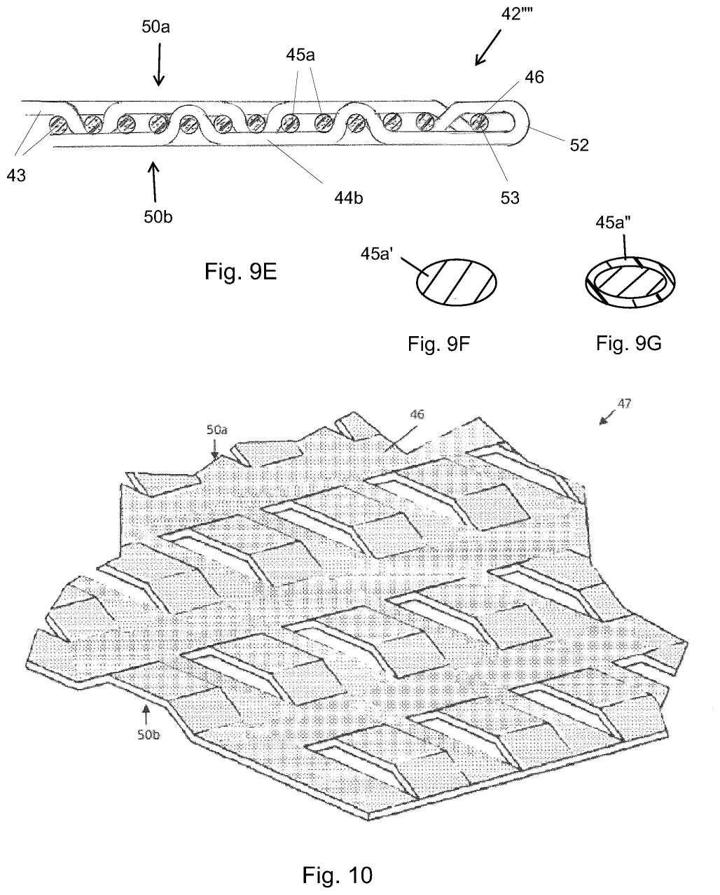

Referring to FIGS. 9A-E, a section of a woven fabric 42 that forms part of the dryer fabric 40, 40′ according to the invention is shown. The completed dryer fabric may further include one or more needled batts of material joined to the woven fabric 42. The woven fabric 42 comprises opposing surfaces 50a and 50b and filaments 43, which comprise machine direction (MD) filaments 44 and cross machine direction filaments 45 that are woven together according to a repeat pattern. In FIG. 9A the cross machine direction (CD) filaments 45a contain induction heat susceptive material while the machine direction filaments 44b do not comprise induction heat susceptive material indicated as dots 46. The induction heat susceptive material 46 is preferably a magnetic, electrically conductive material having high thermal diffusivity, and can be a material such as graphite, magnetite, carbon steel, galvanized steel, magnetic steel, various blends of stainless steel, copper, aluminum, or other conductive metals, or a non-oxide ceramic material such as silicon carbide, that may be blended in powder form with a polymer used to form the filaments 45a. For example, 3-90 wt % of the conductive material can be blended with a polymer with good high temperature and high humidity performance such as PPS, PEEK, or PCTA, or a non-melt processing aromatic polyamide such as DuPont's Nomex® material, and extruded in order to form the filaments 45a. Those skilled in the art will recognize that other types of polymers as well as other induction heat susceptive materials can be used.

Alternatively, the induction heat susceptive material could be provided in the form of a metal component that is woven into the fabric 42 in one or more of the MD or CD filament positions in the fabric weave in place of or in addition to the polymeric filaments. Such metal components or strands are preferably in either in the MD or the CD, but may be more efficient in one direction based on the coil design or orientation (i.e., when the coil is oriented in the MD the susceptive material in the CD would be more efficient and vice-versa). CD filaments 45a provided as metal strands provide better flexibility for the fabric 42 when combined with polymeric MD filaments 44b. The metal CD strands 45a could be flat, round, or flattened round, such as metal strand 45a′ shown in FIG. 9F. However, metal MD strands 44a are also contemplated, and may have similar configurations. In one preferred embodiment, dimensions for the metal MD strands 44a are 2 mm wide×0.25 mm thick (preferably having a flat cross-sectional profile with a minimum 2:1 to 8:1 strand ratio for greater heating contact area).

As metal to metal contact between components may cause shorts or hot spots, in order to avoid this issue, a combination of metal and polymeric strands is preferred to keep the metal components from touching each other. Accordingly, this could be attained by having metal CD filaments 45a or metal MD filaments 44a preferably placed alternately with polymeric CD filaments 45b or polymeric MD filaments 44b, respectively. Alternatively, for applications requiring a greater contact area of the susceptive material in which all metal strands are provided for the MD strands 44a or the CD strands 45a, if at least some of the metal strands are coated with a polymeric material, such as shown in cross-section in FIG. 9G for coated filament 45″. This could also provide additional protection if a strand breaks but is held together with polymeric coating.

FIG. 9B provides an alternative embodiment of a woven fabric 42′ where the cross machine direction filaments 45b do not contain induction heat susceptive material while the machine direction filaments 44a do contain induction heat susceptive material 46, and can be formed with materials such as those described above in connection with the filaments 45a. Here, it is also possible for the machine direction filaments 44a that contain induction heat susceptive material 46 to be braided or cabled to help prevent fatigue issues

In FIG. 9C, a further alternative embodiment provides a woven fabric 42″ where both the cross machine direction filaments 45a and the machine direction filaments 44a contain induction heat susceptive material 46.

In FIG. 9D, an additional embodiment provides a woven fabric 42′″ where both the machine direction filaments 44a and some of the cross machine direction filaments 45a contain induction heat susceptive material 46, while other cross machine direction filaments 45b do not contain induction heat susceptive material.

In FIG. 9E, an additional embodiment of a woven fabric 42′″ is shown. Similar to the embodiment 42 in FIG. 9A, the cross machine direction filaments 45a contain induction heat susceptive material indicated as dots 46 while the machine direction filaments 44b do not comprise induction heat susceptive material. Additionally, seam loops 52 are shown at one end of the fabric 42′″ and the opposite end would have similar seam loops that could be interdigitated and then joined with a pintle (not shown). Stuffer filaments 53, one of which is illustrated in FIG. 9E for reference purposes, are then inserted in the area of the joined seam loops 52 outside of the area that the pintle occupies. This is preferably done initially after the ends of the fabric 42′″ are joined by the pintle. Here the stuffer filaments 53 also include induction heat susceptive material 46. While the stuffer filaments 46 are illustrated at the seam loop(s), such filaments including the induction heat susceptive material 46 could be inserted in other areas of the fabric, not only in the cross direction, but also in the machine direction.

Referring to FIG. 10, a permeable nonwoven fabric 47 that can be used to form the dryer fabric 40, 40′ according to the invention is shown. The permeable nonwoven fabric 47 comprises opposing surfaces 50a and 50b and comprises induction heat susceptive material 46. The permeable nonwoven 47 may be at least one of a film, an extruded netting, composites or laminates with permeable layers, foams, non-crimp fabrics with multiaxial directional fibers, knits, or spiral fabrics.

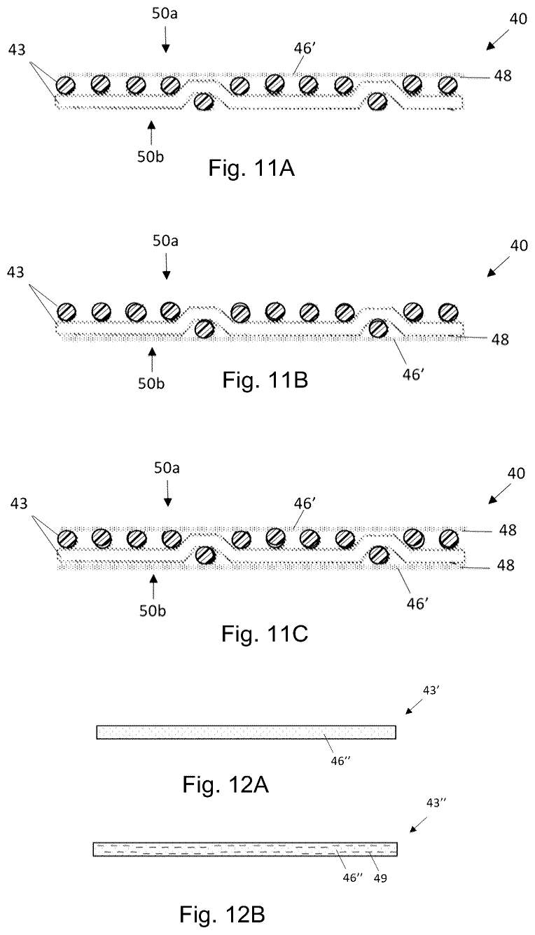

Referring to FIGS. 11A-C, a dryer fabric 40 according to the invention is shown. The dryer fabric 40 comprises opposing surfaces 50a and 50b and comprises an induction heat susceptive material coating 48 comprising an induction heat susceptive material 46′ . In FIG. 11A the induction heat susceptive coating 48 has been applied to the upper surface 50a. In FIG. 11B the induction heat susceptive coating 48 has been applied to the lower surface 50b. In FIG. 11C the induction heat susceptive coating 48 has been applied to both opposing surfaces 50a and 50b. FIGS. 11A-C provide a fabric of woven filaments 43, however the induction heat susceptive coating 48 may also be applied to nonwoven fabrics. The coating 48 may be a pigment of graphite comprising a heat resistant binder. The coating 48 may alternatively comprise small iron particles such as magnetite and a temperature resistant binder to be electrically conductive in one dimension. The coating 48 may be applied to either or both sides of a completed dryer fabric 40. The coating 48 may alternatively or additionally be applied to individual filaments 43 of a woven fabric 42 prior to being woven.

Referring to FIGS. 12A and 12B, embodiments of filaments according to the invention are shown. FIG. 12A provides a conductive filament 43′ comprising induction heat susceptible material 46″ which can be formed for example of graphite, magnetite, carbon steel, galvanized steel, various blends of stainless steel, copper, aluminum, or other conductive metals, or a non-oxide ceramic material such as silicon carbide. FIG. 12B provides a filament 43″ formed as a multi-filament or coextruded as a monofilament that is a combination of conductive induction heat susceptible material 46″ and polymeric material 49, such as the previously mentioned metals or ceramic and a polymer with good high temperature and high humidity performance such as PPS, PEEK, or PCTA, or a non-melt processing aromatic polyamide such as DuPont's Nomex® material. The blend must conduct electricity and preferably be magnetic.

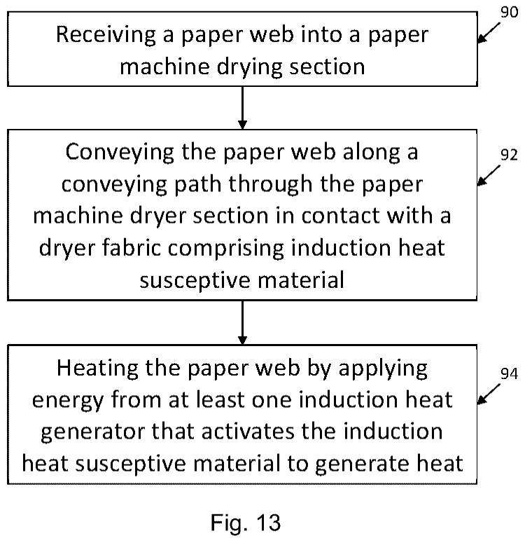

Referring to FIG. 13, a flowchart is provided outlining the steps required to dry the web of material. As shown in box 90, the first step involves receiving a paper web into a paper machine drying section. The second step as provided in box 92 involves conveying the paper web along a conveying path through the paper machine dryer section in contact with a dryer fabric comprising induction heat susceptive material. Box 94 provides the final step for this embodiment of the invention, involving heating the paper web by applying energy from at least one induction heat generator that activates the induction heat susceptive material to generate heat. Preferably, the inductive heat generator heats the dryer fabric comprising induction heat susceptors, which conducts heat to the paper web in order to dry the paper web.

In a preferred embodiment the drying method involves providing a second dryer fabric comprising induction heat susceptors in the paper machine dryer section and conveying the paper web sandwiched between the dryer fabrics along the conveying path through at least a portion of the paper machine dryer section. In a further preferred embodiment, a plurality of induction heat generators are provided spaced apart along the conveying path, and the method further comprises heating the paper web by applying energy from the plurality of induction heat generators that activate the induction heat susceptors to generate heat to dry the paper web. The method may further involve removing moisture from the dryer section by applying one of a vacuum, a roller, a desiccator, or a mass transfer recovery source, preferably by removing moisture from the dryer section by applying a vacuum to the paper web at spaced apart intervals as the paper web is moved along the conveying path. A preferred embodiment also involves forming a dryer fabric with induction heat susceptors in or on the fabric.

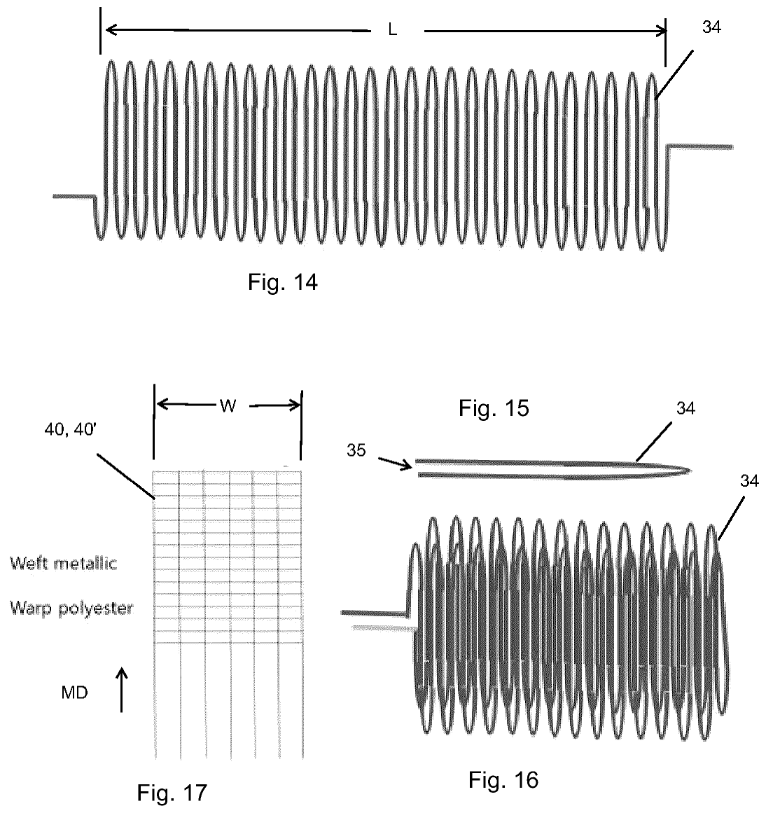

FIGS. 14-16 show another embodiment of an induction heating coil 34 for an induction heat generating cell 32′ that can be used in a dryer section, for example as shown in FIG. 18. FIGS. 15 and 16 show the finished induction heating coil 34 that is used in the induction heat generating cell 32′, and FIG. 14 shows a production step in forming the induction heat generating coil 34. In FIG. 14, the induction heat generating coil 34 is formed of annealed copper tubing or another suitable material with a generally sinusoidal or other periodic curve and has a length L that is at least about two times the width W of a dryer fabric 40, 40′ that it is adapted to be used with. The induction heat generating coil 34 is then bent at a medial position to the configuration shown in FIGS. 15 and 16 so that two portions of the coil 34 face one another and define a gap 35 therebetween for the web path in which the dryer fabric 40, 40′ is adapted to travel.

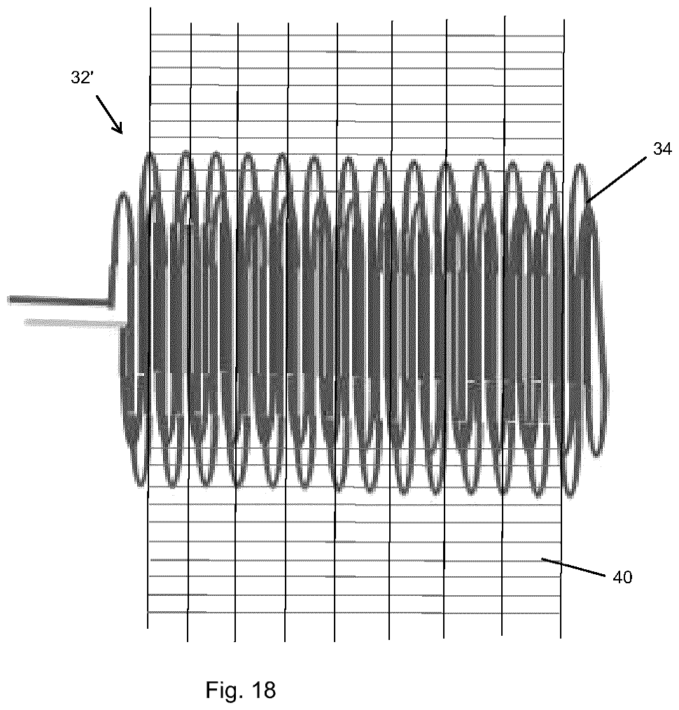

An exemplary dryer fabric 40 is shown in FIG. 17 in which the wefts are metallic or otherwise incorporate an induction heat susceptive material, and the warps, which extend in the machine direction, are made of a polymeric material. FIG. 18 schematically illustrated the dryer fabric 40 extending through the gap 35 in the induction heat generating coil 34.

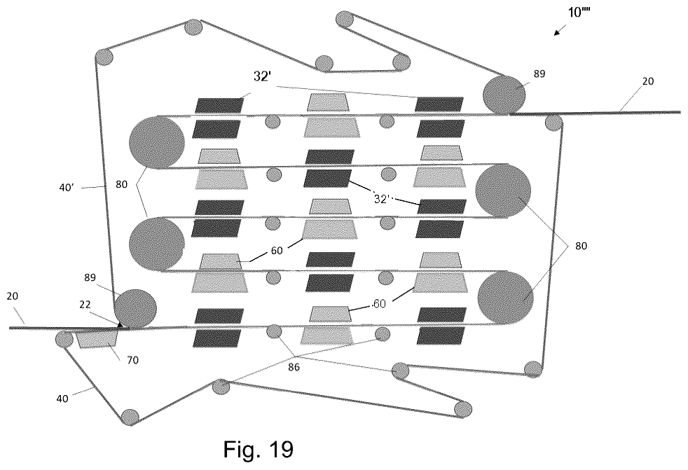

FIG. 19 shows a dryer section 10″″ that is similar to the dryer section 10 in accordance with the first embodiment, that is configured to receive a web of material 20, a paper web, along at least part of a web path of a web support space 22 defined by at least one dryer fabric 40 equipped with induction heat susceptors, and more preferably two dryer fabrics 40, 40′. The dryer section 10″″ has at least one inductive energy generator, shown here as induction heat generating cells 32′ in accordance with FIGS. 15 and 16. The induction heat susceptors of the dryer fabrics 40, 40′ capture the electromagnetic field and produce heat from the eddy currents by the Maxwell-Lodge effect. As the dryer fabrics 40, 40′ convey the web of material 20 through the dryer section 10, they are supported for movement in this embodiment by primary rollers 80, carrier rollers 86, and felt rollers 89. The dryer section 10″″ may also include at least one moisture removal device, in this embodiment represented by stationary vacuums 60. The vacuums may be formed as one or more low vacuum units, which comprise a box connected to a blower which creates a negative air pressure to capture moist air evaporating from the web, using a low suction high volume blower to generate the vacuum. Here, the recovered water vapor can be recycled back into the papermaking process. The dryer section may also include at least one transfer source, in this embodiment represented by a transfer vacuum 70.

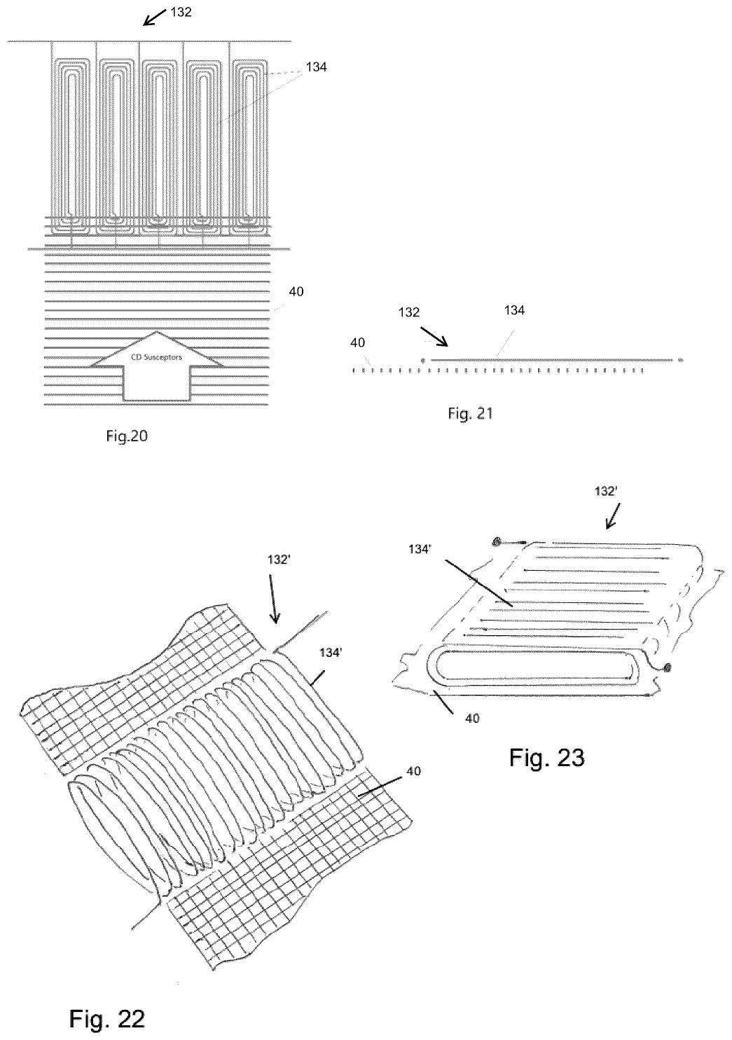

FIGS. 20 and 21 show another embodiment of induction heating coils 134 for an induction heat generating cell 132 that can be used in a dryer section, for example as shown in FIG. 24. FIGS. 20 and 21 show the finished induction heating coils 134 connected individually to the current source of the induction heat generating cell 132. The induction heat generating coils 134 are preferably formed of annealed copper tubing or another suitable material in a pancake form, and are arranged spaced apart in the cross-machine direction of the dryer fabric(s) 40, 40′ flat face adjacent to but not in contact with the dryer fabric 40, 40′.

FIGS. 22 and 23 show another embodiment of an induction heating coil 134′ for an induction heat generating cell 132′ that can be used in a dryer section, for example as shown in FIG. 24. FIGS. 22 and 23 show the finished induction heating coil 134′ connected to the current source of the induction heat generating cell 132′. The induction heat generating coil 134′ is preferably formed of annealed copper tubing or another suitable material in an elongated or flattened single helix coil that spans the cross-machine direction of the dryer fabric(s) 40, 40′ with one side of the coil facing and spaced directly adjacent to but not in contact with the dryer fabric 40′.

Referring to FIG. 24, a further embodiment of a dryer section 110 according to the invention will be described in further detail. The dryer section 110 is configured to receive a web of material 20, a paper web, along at least part of a web path of a web support space 22 defined by at least one dryer fabric 40 equipped with induction heat susceptors, and more preferably two dryer fabrics 40, 40′. The dryer section 110 has at least one inductive energy generator, shown here as induction heat generating cells 132 or 132′. The induction heat generating cells 132, 132′ are preferably as described above such that when energized with electricity, an electromagnetic field is produced. The induction heat susceptors of the dryer fabrics 40′ capture the electromagnetic field and produce heat from the eddy currents by the Maxwell-Lodge effect. As the dryer fabrics 40, 40′ convey the web of material 20 through the dryer section 110, they are supported for movement in this embodiment by the primary rollers 80, the carrier rollers 86, and the felt rollers 89. The dryer section 110 may also include at least one moisture removal device, such as the stationary vacuums 60 described above. The dryer section may also include at least one transfer source, such as the transfer vacuum 70 discussed above.

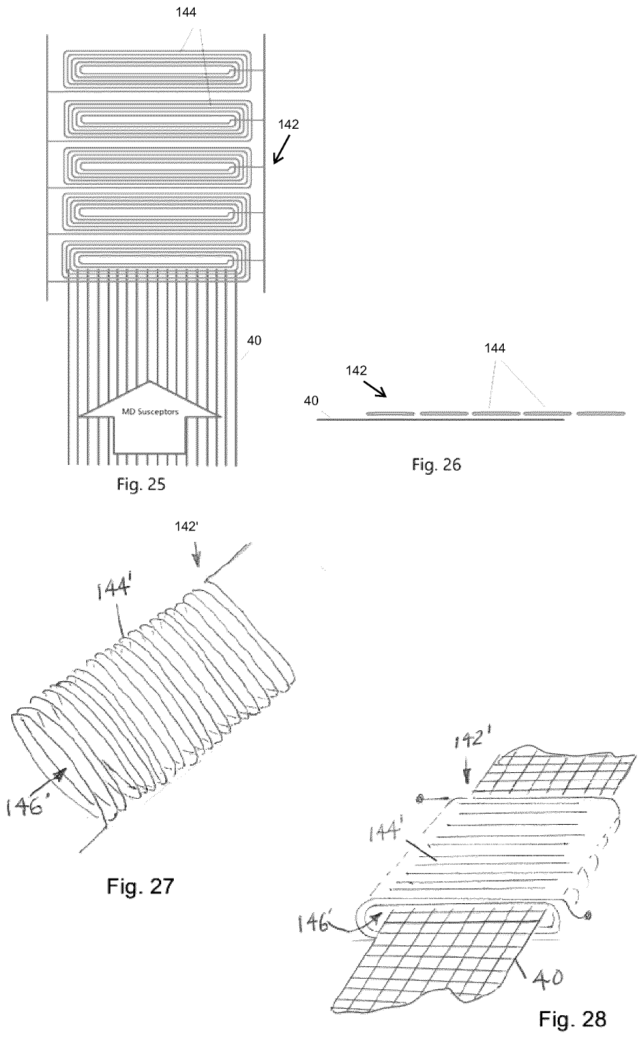

FIGS. 25 and 26 show another embodiment of induction heating coils 144 for an induction heat generating cell 142 that can be used in a dryer section, for example as shown in FIG. 29. FIGS. 25 and 26 show the finished induction heating coils 144 connected individually to the current source of the induction heat generating cell 142. The induction heat generating coils 144 are preferably formed of annealed copper tubing or another suitable material in a pancake form, and are arranged spaced apart in the machine direction flat face adjacent to but not in contact with the dryer fabric 40, 40′. As shown in FIG. 29, the induction heat generating cells 142 can be arranged at multiple positions along the web path in which the dryer fabric(s) 40, 40′ is(are) adapted to travel. They can also be located along the return path of the dryer fabric(s) 40, 40′.

FIGS. 27 and 28 show another embodiment of an induction heating coil 144′ for an induction heat generating cell 142′ that can be used in a dryer section, for example as shown in FIG. 29. FIGS. 27 and 28 show the finished induction heating coil 144′ connected to the current source of the induction heat generating cell 142′. The induction heat generating coil 144′ is preferably formed of annealed copper tubing or another suitable material in an elongated or flattened single helix coil with a central opening 146′ defined through a center thereof that extends in a machine direction. The dryer fabric(s) 40, 40′ extend in the machine direction through the central opening 146′ so that the segments of the coil 144′ are adjacent to both sides of but not in contact with the dryer fabric(s) 40, 40′. As shown in FIG. 29, the induction heat generating cells 142′ can be arranged at multiple positions along the web path in which the dryer fabric(s) 40, 40′ is(are) adapted to travel. They can also be located along the return path of the dryer fabric(s) 40, 40′.

Referring to FIG. 29, a further embodiment of a dryer section 210 according to the invention will be described in further detail. The dryer section 210 is configured to receive a web of material 20, a paper web, along at least part of a web path of a web support space 22 defined by at least one dryer fabric 40 equipped with induction heat susceptors, and more preferably two dryer fabrics 40, 40′. The dryer section 210 has at least one inductive energy generator, shown here as induction heat generating cells 142 or 142′. The induction heat generating cells 142, 142′ are preferably as described above such that when energized with electricity, an electromagnetic field is produced. The induction heat susceptors of the dryer fabrics 40, 40′ capture the electromagnetic field and produce heat from the eddy currents by the Maxwell-Lodge effect. As the dryer fabrics 40, 40′ convey the web of material 20 through the dryer section 210, they are supported for movement in this embodiment by the primary rollers 80, the carrier rollers 86, and the felt rollers 89. The dryer section 210 may also include at least one moisture removal device, such as the stationary vacuums 60 described above. The dryer section may also include at least one transfer source, such as the transfer vacuum 70 discussed above.

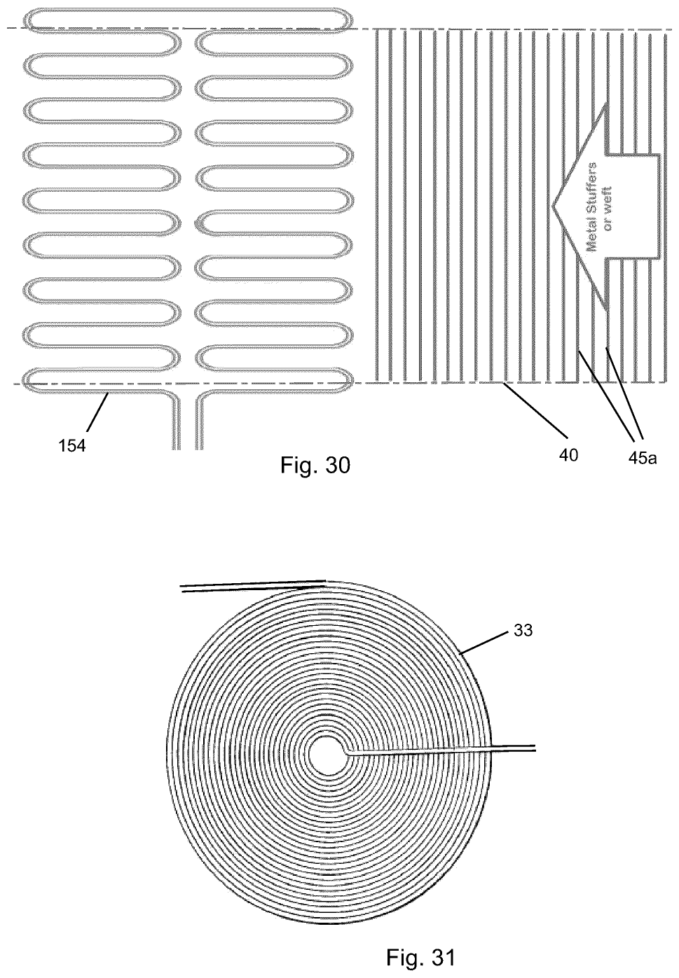

Referring now to FIG. 30, another embodiment of an induction heating coil 154 for an induction heat generating cell that can be used in a dryer section, for example as shown in any of the prior figures, is shown. The induction heating coil 154 is preferably formed of annealed copper tubing or another suitable material with a generally sinusoidal or other periodic curve that extends across the width W of a dryer fabric 40, 40′ that it is adapted to be used with and then extends back along a parallel path that is offset in the machine direction of the dryer fabric 40. Here, the dryer fabric is illustrated with cross-machine direction yarns 45 that are made at least in part of the induction heat susceptive material.

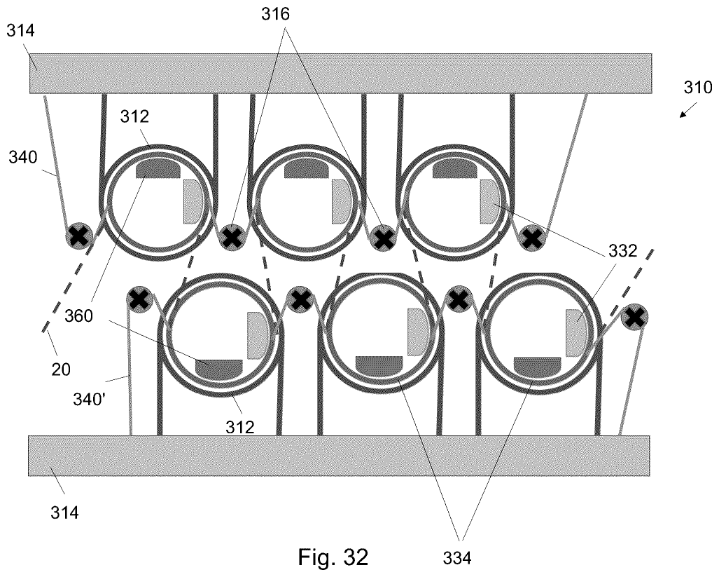

Referring to FIG. 32, a further embodiment of a dryer section 310 is described. The dryer section 310 is configured to receive a web of material 20, a paper web, along at least part of a web path of a web support space defined by at least one dryer fabric 340, and more preferably two dryer fabrics 340, 340′. The dryer fabrics 340, 340′ run around a series of dryer cylinders 334 and driven felt pocket rolls 136. The dryer section 310 has at least one inductive energy generator, shown here as induction heat generating cells 332, mounted across the interior face of the dryer cylinders 334. Bearings 312 are also provided that surround and rotatably support the outer radius of the cylinders. The top cylinders are suspended from the machine frame 314 and bottom cylinders being supported by the frame 314. An induction heat generating cell 332 may be a coiled, annealed, copper tubing that when energized with electricity produces an electromagnetic field. The induction heat susceptors are formed by the dryer cylinders 334 themselves instead of in the dryer fabrics 340, 340′. They capture the electromagnetic field and produce heat from the eddy currents by the Maxwell-Lodge effect. The dryer section may also include at least one moisture removal device, in this embodiment represented by vacuum boxes 60, also located within the dryer cylinders 334.

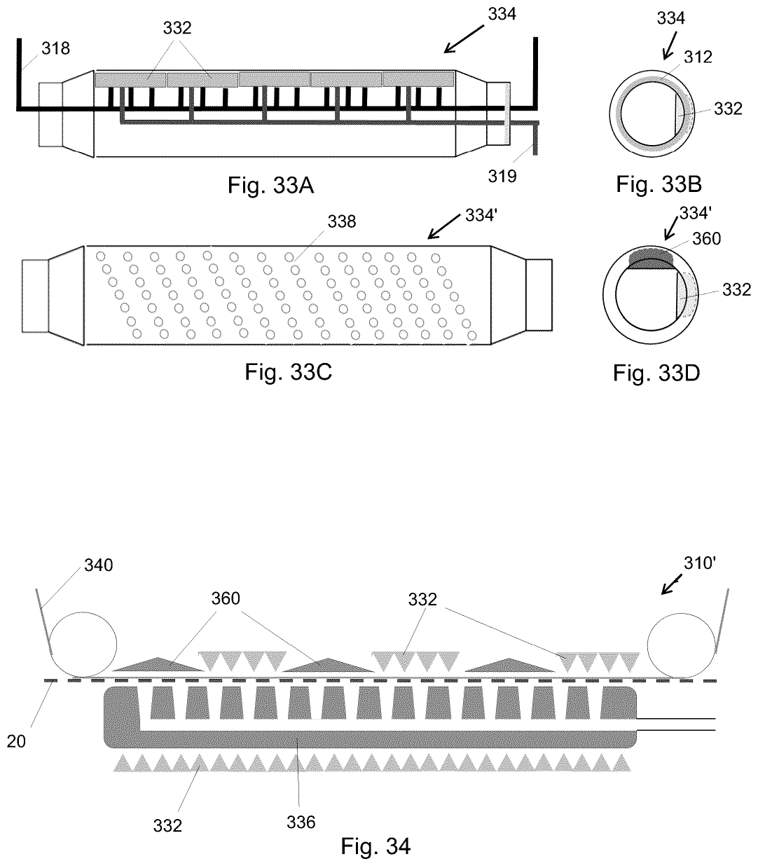

Referring to FIGS. 33A-33D, various views of a dryer cylinder 334 are provided. FIG. 33A provides a schematic cross-sectional side view through the solid shell dryer cylinder 334, with the induction heat generating cells 332 mounted across the width of the interior face. The induction heat generating cells 332 are anchored to the frame of the dryer section by a steel framework 318 that mounts to the existing dryer section framework and passes through the dryer cylinder 334 that the induction heat generating cells 332 are mounted on. A power and DCS control supply 319 is also provided. FIG. 33B is an end view of the dryer cylinder 334 of FIG. 33A, with an induction heat generating cell 332 visible within the dryer cylinder 334 and a bearing 312 provided that rotatably supports the dryer cylinder 334. One bearing 312 is preferably located at each end of the cylinder 334. FIG. 33C provides a schematic side elevational view of a dryer cylinder 334′ with a perforated or drilled shell 338 where moisture can be pulled through into the vacuum boxes 60 located within. FIG. 33D is an end view of the dryer cylinder 334′ of FIG. 33C, with an induction heat generating cell 332 and a vacuum box 360 visible within the dryer cylinder 334′. Bearings such as the bearings 312 noted above, would be located at each end of the dryer cylinder 34′ to allow rotation.

Referring to FIG. 34, a further embodiment of a dryer section 310′ according to the invention is shown. This embodiment of the dryer section 310′ includes induction heat generating cells 332 and an induction heat susceptor plate 336 located on one side of the sheet run while the other side of the sheet run has alternating induction heat generating cells 332 and vacuum boxes 360 along the web path of the web of material 20. The induction heat susceptor plate 336 is a steel plate located proximate to the web of material 20, and preferably includes a plurality of openings that can be connected to a vacuum source. The vacuums may be formed as one or more low vacuum units, a box connected to a blower which creates a negative air pressure to capture moist air evaporating from the web, using a low suction high volume blower to generate the vacuum.

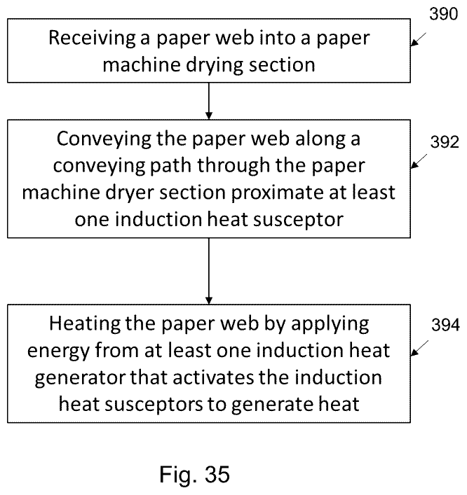

Referring to FIG. 35, a flowchart is provided outlining the steps required to dry the web of material. As shown in box 390, the first step involves receiving a paper web into a paper machine drying section. The second step as provided in box 392 involves conveying the paper web along a conveying path through the paper machine dryer section proximate at least one induction heat susceptor. Box 394 provides the final step for this embodiment of the invention, involving heating the paper web by applying energy from at least one induction heat generator that activates the at least one induction heat susceptor to generate heat. Preferably, the inductive heat generator heats the at least one induction heat susceptor, which conducts heat to the paper web in order to dry the paper web.

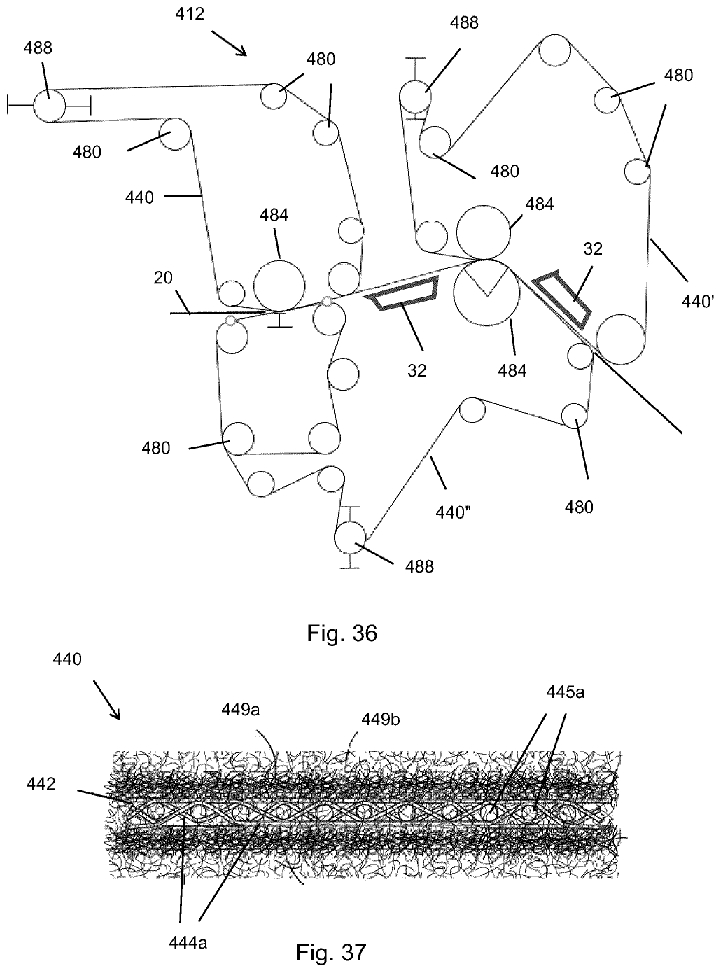

Referring to FIG. 36, an exemplary press section 412 is shown. In use, the press section 412 is upstream of the dryer section 10. Here there are one or more press fabrics or felts 440, 440′, 440″ that carry the web of material 20 from the forming section through at least one nip formed between press rollers 484 in the press section 412 in order to remove moisture from the web of material 20. The press fabrics 440, 440′, 440″ are carried on rollers 480, and driven by the press rollers 484. Tension rollers 488 are provided for tensioning the press fabrics 440, 440′, 440″. Here, induction heat generating cells 32, as discussed above, are located along the path of the press fabrics 440, 440′, 440″, and one or more of the press fabrics include the induction heat susceptive material, in the base fabric and/or in the batt or a scrim needled to the base fabric. The induction heat susceptive material can be incorporated as discussed above in connection with the dryer fabrics 40, 40′.

Referring to FIG. 37, an exemplary section of a press felt 440 is shown. Here, the base fabric 442 is made of machine direction filaments 444a and cross machine direction filaments 445a, similar to the filaments 44a, 45a discussed above, either or both of which may comprise the induction heat susceptive material 46. Additionally, one or more layers of batt fibers 449a, 449b are needled to the base fabric 442, and the batt fiber 449 may also include the induction heat susceptive material of the types discussed above. While a woven base fabric 442 is shown, it is also possible to use a non-woven base fabric.

The additional heat in the press section 412 also helps to remove moisture from the web of material, in addition to the mechanical moisture removal via squeezing the web of material 20 through the press nip and via suction boxes that may be located along the path of the web of material 20.

The above embodiments of the dryer section and press section, industrial textile, and method of drying paper are considered to be exemplary.

While the preferred embodiments are described primarily in conjunction with the dryer section 10 of a papermaking machine or press section 412, other applications where this technology may be applied include: other areas of the dryer section of paper machines, as well as uni-run, sizing press, during or after coating; press felts with susceptive material and an induction coil used along with or to replace a steam box to heat the wet sheet as is passes over the vacuum boxes, and/or when passing through nips; industrial textiles with susceptive material used with an induction coil in the forming section of the paper machine used to heat the wire for heat input locally to reduce viscosity for drainage; induction coil(s) located between the press and dryer sections; industrial textiles with susceptive material for pulp machine applications; press felts with induction susceptive material in the batt fiber; press felts with induction susceptive mesh embedded near paper side surface; industrial textiles with susceptive material for use in extended nip press (ENP) applications; and various other papermaking applications.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

1. A papermaking machine comprising:
at least one of a dryer or a press section configured to receive a web of material,
at least one inductive energy generator, and
first and second fabrics comprising induction heat susceptors, the first and second fabrics are supported for movement through the at least one of the dryer or press sections and adapted to contact the web of material.

2. The papermaking machine of claim 1, wherein the first fabric is located proximate to the second fabric along at least a part of a web path to define a web support space therebetween in which the web of material is adapted to be carried.

3. The papermaking machine of claim 1, wherein at least one of the fabrics comprising the induction heat susceptors is a woven fabric comprising a plurality of filaments wherein at least a portion of the filaments comprise induction heat susceptive material.

4. The papermaking machine of claim 1, wherein at least one of the fabrics comprising the induction heat susceptors is a permeable nonwoven fabric comprising an induction heat susceptive material.

5. The papermaking machine of claim 1, wherein at least one of the fabrics comprising the induction heat susceptors is a fabric comprising an induction heat susceptive coating.

6. The papermaking machine of claim 1, wherein the at least one induction energy generator is selected from at least one of an induction heat generating cell or a thermal insulated rotary roller.

7. The papermaking machine of claim 6, wherein the at least one induction energy generator is an induction heat generating cell.

8. The papermaking machine of claim 7, wherein the induction heat generating cell includes an induction heating coil with an opening defined through the coil, and the web path in which the fabrics are adapted to travel extends through the opening.

9. The papermaking machine of claim 7, wherein the induction heat generating cell includes an induction heating coil located adjacent to the first and second fabrics.

10. The papermaking machine of claim 1, wherein the at least one inductive energy generator comprises a plurality of inductive energy generators.

11. The papermaking machine of claim 10, wherein the plurality of inductive energy generators are offset.

12. The papermaking machine of claim 10, wherein the plurality of induction energy generators are staggered.

13. The papermaking machine of claim 1, wherein the at least one of the dryer section or press section comprises a plurality of dryer sections.

14. An industrial textile comprising a fabric having first and second opposing surfaces, and an induction heating susceptive material.

15. The industrial textile of claim 14, wherein the industrial textile is a dryer fabric or a press fabric for a papermaking machine.

16. The industrial textile of claim 14, wherein the industrial textile is woven or a permeable nonwoven.

17. The industrial textile of claim 14, wherein the induction heating susceptive material is selected from at least one of induction heating susceptive filaments or induction heating susceptive fibers.

18. The industrial textile of claim 17 wherein the filaments are formed of a conductive material.

19. The industrial textile of claim 17, wherein the filaments are a combination of conductive and polymeric materials.

20. The industrial textile of claim 14, wherein the induction heating susceptive material is a coating on at least one of the first or second opposing surfaces.

21. The industrial textile of claim 14, wherein the induction heating susceptive material contains at least one of graphite, carbon steel, galvanized steel, stainless steel, copper, aluminum, silicon carbide or magnetite.

22. A method of drying a paper web comprising:
receiving a paper web in a paper machine section, preferably at least one of a press section or a dryer section;
conveying the paper web along a conveying path through the paper machine section in contact with a fabric comprising induction heat susceptors, and
heating the paper web by applying energy from at least one induction heat generator that activates the induction heat susceptors to generate heat;
wherein the inductive heat generator generates heat in the fabric comprising induction heat susceptors which heats the paper web.

23. The method of claim 22, further comprising:
providing a second fabric comprising induction heat susceptors in the paper machine section; and
conveying the paper web sandwiched between the fabrics along the conveying path through at least a portion of the paper machine section.

24. The method of claim 22, wherein the at least one induction heat generator comprises a plurality of induction heat generators that are spaced apart along the conveying path, and the method further comprises heating the paper web by applying energy from the plurality of induction heat generators that activate the induction heat susceptors to generate heat to dry the paper web.

25. The method of claim 22, further comprising:
forming the fabric with induction heat susceptors in or on the fabric.
